(19) United States
(12) Patent Application Publication
(10) Pub. No.: US 2008/0090954 A1
(43) Pub. Date: Apr. 17, 2008

(54) Low shrinkage sheet molded composite formulations

(75) Inventors: Michael J. Sumner, Dublin, OH (US); Timothy A. Tufts, Powell, OH (US); Dennis H. Fisher, Westerville, OH (US)

Correspondence Address: Connolly Bove Lodge & Hutz LLP, Suite 800, 1990 M. Street, N.W., Washington, DC, 20036, US

(73) Assignee: Ashland Licensing and Intellectual Property LLC, Dublin, OH (US)

(21) Appl. No.: 11/581,381

(22) Filed: Oct. 17, 2006

(51) Int. Cl. C08G 18/42

(52) U.S. Cl. 524/500

(57) ABSTRACT

Low shrinkage sheet molded composite (SMC) formulations and methods for producing low shrinkage sheet molded composites from the SMC formulations are provided. Thermosetting low (LPA) profile additive compositions and the use of thermosetting LPA compositions in producing low shrinkage sheet molded composites are also provided. The LPA compositions allow for the production of sheet molded composites with a high quality surface profile which have both high mechanical and dimensional stability.

### TECHNICAL FIELD

The present disclosure relates to low shrinkage sheet molded composite (SMC) formulations and methods for producing low shrinkage sheet molded composites from the SMC formulations. The disclosure also relates to thermosetting low (LPA) profile additive compositions and the use of thermosetting LPA compositions in producing low shrinkage sheet molded composites. The LPA compositions provide for sheet molded composites with a high quality surface profile while providing for high mechanical and dimensional stability in the sheet molded composite.

### BACKGROUND OF THE INVENTION

Thermosetting polymeric resins reinforced with glass fibers are used extensively as component parts in the transportation industry. The cured fiber reinforced materials have many applications in the transportation industry due to a high strength to weight ratio relative to metal and good heat resistance. Also these materials enable manufacturers to consolidate multi-component metal parts into one composite part. However, due to shrinkage, crosslinked polyester composite materials typically have poor surface quality or surface “profile”. The surface profile or quality is poor due to large peaks and valleys which can be observed using several different analytical techniques. Considerable efforts have been made by resin and part manufacturers to improve the surface profile and dimensional stability of these materials.

A number of thermoplastic additives have been used to improve the surface quality of polyester based composite parts. For example, U.S. Pat. No. 3,959,209, lists thermoplastics which improve the surface quality of composite materials. Some thermoplastics include polystyrene, polyesters, polyacrylates, polymethacrylates, polyvinyl acetate, polyurethanes and various polyglycols. These materials substantially improve the surface profile by reducing resin shrinkage. The reduction in shrinkage results in a material with a smoother surface appearance. Thermoplastics that reduce the profile of a composite part are referred to as low profile additives (LPA's). The use of thermoplastics as LPA's to eliminate shrinkage may reduce the mechanical properties of the final composite material due to plasticization. This is especially true if too much thermoplastic LPA is added to the SMC formulation.

Ideally, the LPA's should eliminate shrinkage while at the same time provide for good mechanical properties by eliminating any deleterious effects due to the use of the LPA. More ideally, the LPA should actually improve the mechanical properties of the SMC.

### BRIEF SUMMARY OF THE INVENTION

The present disclosure relates to a sheet molded composite (SMC) formulation comprising an unsaturated polyester resin and a thermosetting low profile additive (LPA). The thermosetting LPA comprises a polymer modified with an unsaturated group that is capable of free radical initiated crosslinking.

The disclosure additionally relates to a method of producing a sheet molded composite. The method involves blending an unsaturated polyester resin with a thermosetting LPA to form a resin mixture and then optionally adding additional additives to the resin mixture. The resin mixture is then blended with a catalyst to form a SMC formulation and the SMC formulation is then placed into a mold and allowed to cure to form a SMC composite.

The disclosure also relates to a thermosetting LPA composition comprising a polymer modified with an unsaturated group that is capable of free radical initiated crosslinking. Methods for producing thermosetting LPA compositions are also disclosed.

Still other objects and advantages of the present disclosure will become readily apparent by those skilled in the art from the following detailed description, wherein it is shown and described only in the preferred embodiments, simply by way of illustration of the best mode. As will be realized, the disclosure is capable of other and different embodiments, and its several details are capable of modifications in various obvious respects, without departing from the disclosure. Accordingly, the description is to be regarded as illustrative in nature and not as restrictive.

### DETAILED DESCRIPTION AND VARIOUS MODES

The low shrinkage SMC formulations comprise an unsaturated polyester resin and a thermosetting low profile additive (LPA). The thermosetting LPA comprises a polymer or copolymer modified with unsaturated groups capable of free radical initiated crosslinking. The unsaturated groups capable of free radical initiated crosslinking can crosslink into the unsaturated polyester resin network during cure of the SMC formulation. This crosslinking of the LPA into the polyester resin provides for a SMC with minimal shrinkage and good profile properties while also providing for good mechanical properties. However, a balance must be struck with regard to the degree of crosslinking of the thermosetting LPA with the unsaturated polyester resin (PE resin). Too much LPA crosslinking with the polyester can result in too much shrinkage. Too little LPA crosslinking with the polyester can result in too much plasticizing and result in reduced mechanical properties which can occur with the use of thermoplastic type LPA additives. Accordingly, the reactivity and number of unsaturated groups on the polymer of the thermosetting LPA must be controlled for good performance. Typically, the LPA content is from about 5 to about 30 parts by weight per 100 parts of the polyester resin, copolymerizable solvent and LPA. More typically, the LPA content is from about 8 to about 15 parts by weight per 100 parts of the polyester resin, copolymerizable solvent and LPA. Typically, the PE resin content is from about 20 to about 70 parts by weight per 100 parts of the polyester resin, copolymerizable solvent and LPA. More typically, the PE resin content is from about 30 to about 50 parts by weight per 100 parts of the polyester resin, copolymerizable solvent and LPA.

The polymer or copolymer of the thermosetting LPA that is modified with an unsaturated group includes polystyrene, polyester, polyacrylate, polymethacrylate, polyacrylate, polymethacrylate, polyvinyl acetate, polyurethane, polyepoxide, polyglycol and combinations thereof. Mixed copolymers of two or more of the monomers styrene, vinyl acetate, acrylates such as acrylic acid and methyl acrylate, methacrylates such as methacrylic acid and methyl methacrylate, vinyl acetate, vinyl chloride, urethanes, epoxides and glycols may also be used.

The unsaturated group that modifies the polymer of the thermosetting LPA includes styrenic, methacrylic, acrylic, allylic, nadic, fumaric and combinations thereof.

The unsaturated polyester resin is not limited and can include any unsaturated polyester resin suitable for use in a SMC formulation. The unsaturated polyester resin is prepared by reacting a dicarboxylic acid or dicarboxylic anhydride with a polyol.

Typically, the dicarboxylic acid or dicarboxylic anhydride is selected from the group consisting of isophthalic acid, phthalic acid, phthalic anhydride, terephthalic acid, maleic anhydride, maleic acid, fumaric acid, adipic acid, cyclohexane dicarboxylic acid and mixtures thereof.

Typically, the polyol is selected from the group consisting of ethylene glycol, propylene glycol, diethylene glycol, dipropylene glycol, neopentyl glycol, hexanediol, butanediol, 1,3-propanediol, cyclohexanedimethanol, polyethylene glycol, polypropylene glycol and mixtures thereof.

The unsaturated polyester resin polymer may also be chain extended. The resin is typically chain extended with glycidyl esters of bisphenol A, glycidyl esters of linear and cycloaliphatics, phenol-formaldehyde novolacs, an aliphatic fatty acid, an aliphatic fatty ester, a polyether, a glycol, a polyamine and optionally substituted cyclohexane.

The unsaturated polyester resin polymer may also be capped with hydroxyl groups. The hydroxyl group capped polymer may be chain extended with an isocyanate compound. The isocyanate compound is not limited and typically includes at least one compound selected from the group consisting of toluene diisocyanate, methylene di-para-phenylene isocyanate and isophorone diisocyanate.

The SMC formulation may also include an unsaturated solvent that is copolymerizable with the unsaturated polyester resin. The unsaturated (copolymerizable) solvent is not limited and typically includes at least one compound selected from the group consisting of styrene, vinyl toluene, a methacrylic ester, an acrylic ester, divinyl benzene, a multifunctional acrylate, a multifunctional methacrylate and diallylphthalate. Typically, the copolymerizable solvent content is from about 0 to about 70 parts by weight per 100 parts of the polyester resin, copolymerizable solvent and LPA. More typically, the copolymerizable solvent content is from about 15 to about 60 parts by weight per 100 parts of the polyester resin, copolymerizable solvent and LPA. Eve more typically, the copolymerizable solvent content is from about 25 to about 50 parts by weight per 100 parts of the polyester resin, copolymerizable solvent and LPA.

The SMC formulation may optionally contain additives typically used in SMC formulations. The optional additives include at least one of a filler, a reinforcement material, a release agent, a low shrink enhancer, an impact modifier, a pigment, a dye, a stabilizer and a viscosity modifier. The additives are added in amounts that are typically for SMC formulations.

The optional filler additive included in the SMC formulation is not limited and typically includes at least one filler selected from the group consisting of calcium carbonate, clay, kaolin, alumina, talc, glass microspheres, silica, mica, titania, wollastonite, calcined clay and precipitated calcium carbonate.

The optional filler is typically added in amount of from about 50 to about 1000 parts by weight per 100 parts of the polyester resin, copolymerizable solvent and LPA. More typically, the filler is added in an amount of from about 75 to about 400 parts by weight per 100 parts of the polyester resin, copolymerizable solvent and LPA.

The optional reinforcement material is not limited and includes any material which can provide mechanical strength to the SMC formulation. The reinforcement material is typically at least one material selected from the group consisting of fiber glass, carbon fiber, plastic fiber such as PET, natural fiber such as jute, hemp and kenaf, asbestos fiber, boron nitride whiskers, Kevlar®, silicon carbide, mica and wollastonite.

The optional release agent includes fatty acids and metal salts of fatty acids. Typical compounds include at least one compound selected from the group consisting of stearic acid, lauric acid, calcium stearate, zinc stearate, magnesium stearate, sodium laurate, calcium laurate, zinc laurate, magnesium laurate and sodium laurate.

The optional viscosity modifier includes any Group II metal oxide or Group II metal hydroxide. Typically, calcium oxide, calcium hydroxide, magnesium hydroxide, magnesium oxide and mixtures thereof are used. In addition, zinc oxide, tin oxide and mixtures thereof may also be used individually or in combination with any of the viscosity modifiers listed above.

The SMC formulation comprising the unsaturated polyester resin and thermosetting low profile additive can be cured into a network using a polymerization catalyst. Typically, the polymerization catalyst is a peroxide compound or an azo compound. When a peroxide compound is used as a catalyst, the peroxide compound is typically at least one compound selected from the group consisting of benzoyl peroxide, dicumyl peroxide, methyl ethyl ketone peroxide, lauryl peroxide, cyclohexanone peroxide, amyl peroctate, t-butyl perbenzoate, t-butyl hydroperoxide, t-butyl benzene hydroperoxide, and t-butyl peroctoate.

When an azo compound is used as a catalyst, the azo compound is typically at least one compound selected from the group consisting of azobisisobutyronitrile, 2-t-butylazo-2-cyano-4-methylpentane and 4,5-butylazo-4-cyano-valeric acid.

The catalyst is used in an amount of from about 0.1 to about 10 parts by weight per 100 parts of the unsaturated polyester resin, copolymerizable solvent and LPA.

The following examples are for illustrative purposes only and are not intended to limit the scope of the claims.

### Synthesis of Thermosetting Low Profile Additives Using Glycidyl Methacrylate

A one-liter kettle is equipped with a mechanical stirrer, nitrogen inlet, and one thermocouple. Polyvinyl acetate-crotonic acid (PVAc/CA) copolymer (dissolved 30 to 50% by weight in styrene) or polymethyl methacrylate-n-butylmethacrylate-methacrylic acid (PMMA/n-BuMA/MAA) copolymer (dissolved 30 to 50% by weight in styrene), glycidyl methacrylate (GMA), tetramethyl aluminum chloride catalyst (dissolved 40% by weight in ethylene glycol), and parabenzoquinone is charged to the reactor such that a molar ratio of GMA to carboxylic acid ranges from 1.6:1 to 0.05:1. After rapidly stirring at room temperature for several minutes, the solution is heated to 120° C. while stirring is maintained. The reaction is kept at this temperature until the desired modification of acid groups is reached which ranges between 5 and 100% depending upon the desired level of functionalization of the PVAc or PMMA copolymer. The reaction is then cooled to 80° C., poured into a container, and allowed to cool to room temperature.

### Synthesis of Thermosetting Low Profile Additives Using Hydroxylethyl Methacrylate and Diisocyanates

A one-liter kettle is equipped with a mechanical stirrer, nitrogen inlet, and one thermocouple. Polyvinyl acetate-vinyl alcohol (PVAc/NVA) copolymer (dissolved 30 to 50% by weight in styrene) or polymethyl methacrylate-n-butylmethacrylatehydroxylpropyl methacrylate (PMMA/n-BuMA/HPMA) copolymer (dissolved 30 to 50% by weight in styrene), toluene diisocyanate (TDI) or isophorone diisocyanate (IPDI), and dibutyltin dilaurate or stannous octoate is charged to the reactor such that a molar ratio of diisocyanate to hydroxyl group ranges from 1:1.6 to 1:0.05. The ratio of diisocyanate to hydroxyl group varies depending upon the desired % conversion of hydroxyl groups. After rapidly stirring at room temperature for several minutes the solution is heated to 80° C. and allowed to react for 2 hrs. While maintaining at 80° C., the appropriate amount of hydroxylethyl methacrylate (HEMA) is added to the solution to react with the remaining isocyanate groups. The reaction is then cooled to ˜60° C., poured into a container, and allowed to cool to room temperature.

### Synthesis of Thermosetting Low Profile Additives Using Hydroxylpropyl Methacrylate and Diisocyanates

A one-liter kettle is equipped with a mechanical stirrer, nitrogen inlet, and one thermocouple. Hydroxylpropyl methacrylate and toluene diisocyanate (TDI) or isophorone diisocyanate (IPDI) are charged to the reactor such that a ratio of hydroxyl group to diisocyanate ranges from 2:1 to 1.05:1. The (HPMA-TDI or IPDI) solution is rapidly stirred at room temperature for several minutes then dibutyl tin dilaurate or stannous octoate is added and the reaction is allowed to exotherm to 80° C. The reaction is maintained at 80° C. for 2 hrs. The reaction is allowed to cool to 60° C., poured into a container, and then allowed to cool to room temperature.

The second step involves charging polyvinylacetate (containing primary hydroxyl groups) copolymer (dissolved 30 to 50% by weight in styrene) or polymethyl methacrylate-n-butyl-methacrylate-hydroxylethyl methacrylate (HEMA) copolymer (dissolved 30 to 50% by weight in styrene) solution and HPMA-TDI or IPDI solution to a one-liter kettle equipped with a thermocouple, nitrogen inlet, and mechanical stirrer. The HPMA-TDI or 1 PDI solution is charged to the reactor such that a ratio of hydroxyl group to isocyanate ranges from 1.6:1 to 1:0.05 depending on the desired level of hydroxyl conversion along the copolymer chain. After the solution is stirred rapidly at room temperature for several minutes dibutyl tin dilaurate or stannous octoate is then charged to the reactor and the solution is heated to 80° C. for 2 hrs. Upon completion of the reaction the solution is cooled to 60° C., poured into a container, and allowed to cool to room temperature.

### EXAMPLE 1

### Shrinkage Control Measurements of SMC Formulations Containing Thermosetting Low Profile Additives

Several different formulations are evaluated in terms of shrink control by blending unsaturated polyester resins with different thermosetting LPA/styrene solutions. Styrene is added as necessary to adjust polymer percentages in the mixture. 100 parts contain approximately 42-43% UPE, 14% thermosetting LPA, 43-44% styrene and 0.5% of a 12% solution of cobalt (OMG 510® 12% COBALT HEX-CEM). To the 100 parts of this mixture, between 35 and 180 parts CaCO₃ filler, 1.5 parts TBPB initiator, and 4.5 parts zinc stearate mold release agent are added. The contents are thoroughly mixed and placed in a machined aluminum frame and molded under pressure at 150° C. for two minutes. The solid part is removed from the mold, allowed to cool, and the dimensions of the part are measured and compared to the dimensions of the frame. The degree of shrinkage is calculated and reported in mils/inch, where mils represent 10⁻³ inches. The following tables show the measured shrinkage for the different formulations where a negative sign in front of the measured shrinkage indicates expansion. Expansion defines the room temperature part as being larger than the dimensions of the room temperature mold that is used to fabricate it.

The results given in Table 1 demonstrate that increasing the % GMA functionalization of LP4016 from 0 to 40% only increases shrinkage by ˜0.5 mil/in. Increasing the % functionalization to 80% only increases shrinkage ˜2.5 mil/in. Increasing the % functionalization of Elvacite 2550 from 0 to 40 or 80% showed only a slight increase in shrinkage of ˜0.5 to 1 mil/in.

### EXAMPLES 2 and 3

### Fabrication of Sheet Molded Composite Containing Thermosetting Low Profile Additives for Mechanical Property Testing

To prepare sheet molding compound, the components listed in example 1 along with the desired thermosetting LPA are thoroughly mixed for several minutes at the same concentration ranges listed in example 1. Once mixing is complete a thickening agent is added, the mixture is thoroughly mixed again for several minutes and 1″ chopped glass reinforcement is added using standard SMC processing equipment. The paste is allowed to thicken undisturbed until a viscosity between 30 and 60 million cPs is achieved. The SMC sheet is then molded into 12″×12″ plaques at 1500 psi for 90 to 120 s at 300° F.(150° C.). The plaques are removed from the mold and allowed to cool to room temperature. Upon cooling to room temperature no warpage of the plaques is observed and the shrink control is adequate. Next the plaques are cut down to the appropriate shape and dimensions for tensile and flexural property testing. The tensile property testing is completed according to ASTM D-368 and the flexural property testing is completed according to ASTM D-790. The results from the mechanical property testing are in given Table 2 and Table 3.

The results given in Table 2 demonstrate that thermosetting LP4016 LPAs at 40 and 80% GMA modification increase many of the flexural and mechanical properties, such as modulus and toughness, by ˜10 to 20%. The results given in Table 3 show the same observations are made for thermosetting Elvacite 2550 LPAs. In some cases such as maximum tensile strength for the 80% GMA modified Elvacite 2550, the increase is greater than 30%.

TABLE 1
Example 1 Shrinkage measurements for standard density (180 phr
CaCO₃, filler) paste plaques containing thermosetting LPAs.
The shrinkage for the thermosetting LPAs is evaluated at three
different % GMA modification levels 0, 40, and 80.

| | % GMA | Shrinkage |
|---|---|---|
| LPA | Modified | (Mil/in) |
| LP4016 ® | 0 | 0.28 ± 0.16 |
| | 40 | 0.74 ± 0.13 |
| | 80 | 2.92 ± 0.24 |
| Elvacite ® 2550 | 0 | 2.66 ± 0.40 |
| | 40 | 3.86 ± 0.01 |
| | 80 | 3.14 ± 0.04 |

LP4016 ®-High Molecular Weight PVAc-AA Copolymer
Elvacite ® 2550-High Molecular Weight MMA/IBMA/MAA Copolymer

TABLE 2
Example 2 Tensile and flexural properties of standard density (180 phr CaCO₃) SMC containing
0 (standard), 40, and 80% GMA modified LP4016.

| | | | | Tensile Properties | | | |
|---|---|---|---|---|---|---|---|
| | Flexural Properties | | | Maximum | | Elongation | |
| | Flexural | Tangent | Toughness | Tensile | | at | |
| SMC ID | Strength | Modulus | at Yield | Strength | Modulus | Break | Toughness |
| (LPA) | (psi) | (ksi) | (in-lbs/in³) | (psi) | (ksi) | (%) | (in-lbs · in³) |
| (Standard | 29090 ± 1159 | 1356 ± 49.2 | 61.8 ± 4.9 | 14090 ± 1398 | 1592 ± 62.1 | 1.53 ± 0.27 | 142.3 ± 20.9 |
| LP4016) | | | | | | | |
| 7063-82- | 31165 ± 1032 | 1389 ± 91.7 | 82.6 ± 11.4 | 15969 ± 1461 | 1728 ± 55.5 | 1.60 ± 0.20 | 163.55 ± 25.9 |
| 2B | | | | | | | |
| (40% | | | | | | | |
| GMA | | | | | | | |
| Modified | | | | | | | |
| LP4016 ®) | | | | | | | |
| 7063-74- | 34072 ± 1925 | 1639 ± 107.8 | 78.4 ± 3.5 | 13576 ± 1140 | 1814.3 ± 142 | 1.70 ± 0.12 | 151.5 ± 26.7 |
| 2A | | | | | | | |
| (80% | | | | | | | |
| GMA | | | | | | | |
| Modified | | | | | | | |
| LP4016 ®) | | | | | | | |

TABLE 3
Example 3 Tensile and flexural properties of standard density (180 phr CaCO₃) SMC containing
0 (standard), 40, and 80% GMA modified Elvacite ® 2550.

| | | | | Tensile Properties | | | |
|---|---|---|---|---|---|---|---|
| | Flexural Properties | | | Maximum | | Elongation | |
| | Flexural | Tangent | Toughness | Tensile | | at | |
| SMC ID | Strength | Modulus | at Yield | Strength | Modulus | Break | Toughness |
| (LPA) | (psi) | (ksi) | (in-lbs/in³) | (psi) | (ksi) | (%) | (in-lbs · in³) |
| (Standard | 27922 ± 2302 | 1497 ± 79.7 | 54.9 ± 6.7 | 12078 ± 879 | 1762 ± 82.9 | 1.57 ± 0.11 | 125.7 ± 5.9 |
| Elvacite ® | | | | | | | |
| 2550) | | | | | | | |
| 7063-84- | 33410 ± 2559 | 1660 ± 59.3 | 69.6 ± 7.3 | 12836 ± 1203 | 1847 ± 70.1 | 1.50 ± 0.10 | 122.2 ± 13.5 |
| 2B | | | | | | | |
| (40% | | | | | | | |
| GMA | | | | | | | |
| Modified | | | | | | | |
| Elvacite ® | | | | | | | |
| 2550) | | | | | | | |
| 7063-78- | 31863 ± 1065 | 1792 ± 135 | 66.8 ± 5.3 | 17234 ± 1189 | 2122 ± 150 | 1.50 ± 0.10 | 158.3 ± 3.4 |
| 2A | | | | | | | |
| (80% | | | | | | | |
| GMA | | | | | | | |
| Modified | | | | | | | |
| Elvacite ® | | | | | | | |
| 2550) | | | | | | | |

The term “comprising” (and its grammatical variations) as used herein is used in the inclusive sense of “having” or “including” and not in the exclusive sense of “consisting only of”. The terms “a” and “the” as used herein are understood to encompass the plural as well as the singular.

The foregoing description illustrates and describes the present disclosure. Additionally, the disclosure shows and describes only the preferred embodiments of the disclosure, but, as mentioned above, it is to be understood that it is capable of changes or modifications within the scope of the concept as expressed herein, commensurate with the above teachings and/or skill or knowledge of the relevant art. The embodiments described hereinabove are further intended to explain best modes known of practicing the invention and to enable others skilled in the art to utilize the disclosure in such, or other, embodiments and with the various modification required by the particular applications or uses disclosed herein. Accordingly, the description is not intended to limit the invention to the form disclosed herein. Also, it is intended that the appended claims be construed to include alternative embodiments.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

What is claimed:

1. A sheet molded composite (SMC) formulation comprising, an unsaturated polyester resin and a thermosetting low profile additive, wherein the thermosetting low profile additive comprises a polymer modified with an unsaturated group that is capable of free radical initiated crosslinking.

2. The SMC formulation as claimed in claim 1, wherein the polymer modified with an unsaturated group is at least one polymer selected from the group consisting of polystyrene, polyester, polyacrylate, polymethacrylate, polyvinyl acetate, polyurethane, polyepoxide and polyglycol.

3. The SMC formulation as claimed in claim 1, wherein the unsaturated group modifying the polymer is at least one group selected from the group consisting of styrenic, methacrylic, acrylic, allylic, nadic and fumaric.

4. The SMC formulation as claimed in claim 1, wherein the unsaturated polyester resin is prepared by reacting a dicarboxylic acid or dicarboxylic anhydride with a polyol.

5. The SMC formulation as claimed in claim 4, wherein the dicarboxylic acid or dicarboxylic anhydride is selected from the group consisting of isophthalic acid, phthalic acid, phthalic anhydride, terephthalic acid, maleic anhydride, maleic acid, fumaric acid, adipic acid, cyclohexane dicarboxylic acid and mixtures thereof.

6. The SMC formulation as claimed in claim 4, wherein the polyol is selected from the group consisting of ethylene glycol, propylene glycol diethylene glycol, dipropylene glycol, neopentyl glycol, hexanediol, butanediol, 1,3-propanediol, cyclohexanedimethanol, polyethylene glycol, polypropylene glycol and mixtures thereof.

7. The SMC formulation as claimed in claim 1, wherein the unsaturated polyester resin polymer chain is extended.

8. The SMC formulation as claimed in claim 7, wherein the unsaturated polyester resin polymer chain is extended with a glycidyl ester of bisphenol A, a glycidyl ester of linear aliphatics, a glycidyl ester of cycloaliphatics, a phenol-formaldehyde novolac, an aliphatic fatty acid, an aliphatic fatty ester, a polyether, a glycol, a polyamine and optionally substituted cyclohexene.

9. The SMC formulation as claimed in claim 1, wherein the unsaturated polyester resin polymer is capped with hydroxyl groups.

10. The SMC formulation as claimed in claim 9, wherein the unsaturated polyester resin polymer capped with hydroxyl groups is chain extended with an isocyanate compound.

11. The SMC formulation as claimed in claim 10, wherein the isocyante compound is at least one compound selected from the group consisting of toluene diisocyanate, methylene di-para-phenylene isocyanate and isophorone diisocyanate.

12. The SMC formulation as claimed in claim 1, wherein the unsaturated polyester resin is diluted for processing with an unsaturated solvent that is copolymerizable with the unsaturated polyester resin.

13. The SMC formulation as claimed in claim 12, wherein the unsaturated solvent is at least one compound selected from the group consisting of styrene, vinyl toluene, a methacrylic ester, an acrylic ester, divinyl benzene, a multifunctional acrylate, a multifunctional methacrylate and diallylphthalate.

14. The SMC formulation as claimed in claim 1, wherein the SMC formulation further comprises at least one of a filler, a reinforcement material, a release agent, a low shrink enhancer, an impact modifier, a pigment, a dye, a stabilizer and a viscosity modifier.

15. The SMC formulation as claimed in claim 14, wherein the SMC formulation comprises filler and the filler is at least one filler selected from the group consisting of calcium carbonate, clay, kaoline, alumina, talc, glass microspheres, silica, mica, wollastonite, calcined clay and precipitated calcium carbonate.

16. The SMC formulation as claimed in claim 14, wherein the SMC formulation comprises a reinforcement material and the reinforcement material is at least one material selected from the group consisting of fiber glass, carbon fiber, asbestos fiber, natural fiber, plastic fiber, PET, jute, hemp, kenaf, boron nitride whiskers, Kevlar®, silicon carbide, mica and wollastonite.

17. The SMC formulation as claimed in claim 14, wherein the SMC formulation comprises a release agent and the release agent is at least one compound selected from the group consisting of stearic acid, lauric acid, calcium stearate, zinc stearate, magnesium stearate, sodium laurate, calcium laurate, zinc laurate, magnesium laurate and sodium laurate.

18. The SMC formulation as claimed in claim 14, wherein the SMC formulation comprises a viscosity modifier and the viscosity modifier is at least one selected from the group consisting of a Group II metal oxide, a Group II metal hydroxide, zinc oxide and tin oxide.

19. The SMC formulation as claimed in claim 1, further comprising a polymerization catalyst.

20. The SMC formulation as claimed in claim 19, wherein the polymerization catalyst is a peroxide compound or an azo compound.

21. The SMC formulation as claimed in claim 20, wherein the polymerization catalyst is a peroxide compound and the peroxide compound is at least one compound selected from the group consisting of benzoyl peroxide, dicumyl peroxide, methyl ethyl ketone peroxide, lauryl peroxide, cyclohexanone peroxide, amyl peroctoate, t-butyl perbenzoate, t-butyl hydroperoxide, t-butyl benzene hydroperoxide and t-butyl peroctoate.

22. The SMC formulation as claimed in claim 20, wherein the polymerization catalyst is a azo compound and the azo compound is at least one compound selected from the group consisting of azobisisobutyronitrile, 2-t-butylazo-2-cyano-4-methylpentane and 4,5-butylazo-4-cyano-valeric acid.

23. A method of producing a sheet molded composite (SMC) comprising:
blending an unsaturated polyester resin with a thermosetting low profile additive to form a resin mixture optionally blending into the resin mixture at least one of an unsaturated solvent, a filler, a reinforcement material, a release agent, a low shrink enhancer, an impact modifier, a pigment, a dye, a stabilizer and a viscosity modifier;
adding a polymerization catalyst to the resin mixture and mixing thoroughly to form a SMC formulation;
placing the SMC formulation into a mold optionally under pressure;
allowing the SMC formulation to cure into a solid article and,
removing the solid article from the mold.

24. An article produced by the method of producing a sheet molded composite (SMC) as claimed in claim 23.

25. A thermosetting low profile additive composition comprising a polymer modified with an unsaturated group that is capable of free radical initiated crosslinking wherein the copolymer is polyvinyl acetate-crotonic acid copolymer or polymethyl methacrylic-n-butylmethacrylate-methacrylic acid copolymer and the polymer is modified with an unsaturated group that is capable of free radical initiated crosslinking by reacting the polymer with glycidyl methacrylate over a catalyst to form the thermosetting low profile additive.

26. A thermosetting low profile additive composition comprising a polymer modified with an unsaturated group that is capable of free radical initiated crosslinking wherein the copolymer is polyvinyl acetate-vinyl alcohol copolymer or polymethyl methacrylate-n-butylmetharcylate-hydroxypropyl methacrylate copolymer and the polymer is modified with an unsaturated group that is capable of free radical initiated crosslinking by reacting the polymer with an isocyanate over a catalyst to form an intermediate composition then reacting the intermediate composition with hydroxylethyl methacrylate to form the thermosetting low profile additive.

27. A thermosetting low profile additive composition comprising a polymer modified with an unsaturated group that is capable of free radical initiated crosslinking wherein the polymer is polyvinylacetate copolymer or polymethyl methacrylate-n-butyl-methacrylate-hydroxy ethyl methacrylate copolymer and the polymer is modified with an unsaturated group that is capable of free radical initiated crosslinking by reacting the polymer with a composition containing an unsaturated group over a catalyst to form the thermosetting low profile additive where, the composition is produced by reacting hydroxypropyl methacrylate with a diisocyanate over a catalyst.

28. The SMC formulation as claimed in claim 1, wherein the polymer modified with an unsaturated group is at least one copolymer formed from the monomers selected from the group consisting of styrene, ester, acrylate, methacrylate, vinyl acetate, urethane, epoxides, glycols and mixtures thereof.
